(19) United States
(12) Patent Application Publication
(10) Pub. No.: US 2008/0196575 A1
(43) Pub. Date: Aug. 21, 2008

(54) Process for creating and viewing digital sheet music on a media device

(75) Inventor: Michael Good, Los Altos, CA (US)

Correspondence Address: DERGOSITS & NOAH LLP, FOUR EMBARCADERO CENTER, SUITE 1450, SAN FRANCISCO, CA, 94111, US

(73) Assignee: Recordare LLC

(21) Appl. No.: 11/707,823

(22) Filed: Feb. 16, 2007

(51) Int. Cl. G09B 15/04

(52) U.S. Cl. 84/470 R; 700/94

(57) ABSTRACT

A novel process and system for presenting and displaying digital sheet music is disclosed. Digitized presentation of sheet music has been enjoyed by technology-savvy musicians and music aficionados for the past few years; however, nothing exists that extends this format into the realm beyond the personal computer, while also preserving the original sound of the master recording. The present invention is a system and process used to create a digital video of digital sheet music that is synchronized to an audio recording, and distributable to multiple media device platforms. The invention enables musicians and music aficionados to hear a song as it is meant to be heard—without synthetic MIDI overlays. The invention also allows the user to see the note being played by observing a real-time display of synchronized digital sheet music. The invention enables transfer of the media file to portable media devices or entertainment/gaming consoles.

### TECHNICAL FIELD

The present invention relates generally to the use of media devices as tools to teach and enjoy music. Specifically, the present invention is a process for producing media files for display on portable and non-portable media and computing devices, wherein the media file contains video content of digital sheet music and audio content synchronized to the digital sheet music.

### BACKGROUND OF THE INVENTION

Learning to play an instrument is a difficult and time-consuming task; however, there are many commercially-available high-technology tools that claim to make this task easier. Such high-technology solutions include computer-based programs that display real time playing of a musical score, as well as audio-video media files that display how an instrument is played as it is being played. Nevertheless, despite recent advancement, little has been done to adapt existing computer-based learning tools to fit the growing non-computer based media device market. To date, no one has met the need satisfied by the present invention.

Sheet music is one area that has seen a great deal of development. As the music publishing industry has adopted new technology, sheet music has evolved into paperless digital formats. Rather than print musical score and produce books of music, different sheet music providers have developed software that displays musical score data on a computer screen. The explosive growth of the Internet led to the modern era of digital sheet music, beginning with the 1997 Sunhawk Solero and SheetMusicDirect web-based systems. Since then, MusicNotes, Sibelius, MusicRain, and others have also entered the market, while FreeHand Systems acquired Sunhawk in 2003.

Most digital sheet music systems go beyond simple reiterations of musical score. Rather than focusing simply on the display of traditional notated sheet music or tablature, they include interactive features such as transpositions, playback at different tempos, substitution of different solo instruments, and muting of particular parts. Typically these choices are made on the computer prior to printing out on paper, or transferring to another device (e.g. a laptop-sized digital music stand for FreeHand; an audio CD for capella playAlong). Some systems, like GuitarVision, GuitarGuru, and iPlayMusic, show animated instrumental playback such as guitar neck/fret finger placement. These products offer the music student some idea of how an instrument should be played; however, these products fail to provide the full auditory and visual experience necessary for complete music instruction. Nearly all of these interactive systems use Musical Instrument Digital Interface (MIDI) playback, which is an artificial computer-rendering of the music. Some programs like Notion and SuperConductor use symbolic technologies besides MIDI that are similarly artificial-sounding. The growth of software samplers and increasingly sophisticated sequencing features in both sequencing and notation software have improved playback dramatically over the years; nevertheless, the playback experience falls far short of a professional recording of studio or live performance, since such renderings leave out major factors like timbre and subtle musical nuance.

Because most listeners are so sensitive to it, timbre is particularly important. Recent musicology research has shown that people can classify music by genre with as little as a quarter-second exposure to music. Clearly, musical timbre is a huge portion of what can be perceived in a quarter-second; nevertheless, today's complicated feature-heavy digital sheet music systems are constrained to artificial playback with symbolic systems, sacrificing musical veracity and sensual appeal in favor of increased interactivity. There are a few digital sheet music systems (such as some MusicNotes variants) that include CD synchronization features so one can synchronize the displayed playback with the correct audio CD; however, these features remain tied to a personal computer and are, at best, quite finicky to operate.

The importance of hearing a live performance by a music student cannot be overemphasized. Musicians and students alike often use practice tape or rehearsal CD systems such as capella playAlong and Music Minus One to learn their parts, even though these systems usually adopt synthesized MIDI playback or re-recordings. They also tend to be audio-only and intended for use together with a paper score. There is nothing available that preserves the artist's original recording in addition to completely displaying the sheet music in digital form such that the student can take it with her.

Some other services have offered piecemeal services, but lack the flexibility instrumental to today's modern music student and music fan. The Keeping Score web site (www.keepingscore.org) offers a score animation synchronized to audio and video of a concert performance,but this is a personal computer-only experience offering an extravagent abundance of multimedia interactivity. This product thus follows in the tradition of computer-based digital sheet music without the flexibility and portability of digital video.

While other variants of music information, such as lyrics or tablature, have been developed for the media device, nothing as of yet has managed to create a product that enables music students to learn music on the go. The only known systems that offer any type of symbolic display on portable media players are some karaoke-based systems that leave out the vocals, and some educational programs that include the display of lyrics and/or chord symbols. Both types of systems usually involve re-recordings of the original performances.

What is needed is a process for developing synchronized digital sheet music that enables a user to listen to a live or master recording of a performance, while following along with the music score. What is needed is a process that enables literate music students to learn music anywhere, especially music that remains true to how the performer intended it to sound, without any artificial or MIDI-based reproductions. What is needed is a process that preserves the timbre and nuance of the original recording, such that the student not only learns how a song is played, but what it is supposed to sound like. Such a product would be extremely desirable and useful to today's music students and music fans.

### SUMMARY OF THE INVENTION

The present invention provides a process for producing a media file containing audio content synchronized to digital sheet music video content. The media file is adapted for display on a wide array of media devices, such as a personal computer, cell phone, Apple Video iPod or Microsoft Zune, or for display using an entertainment console, such as the Microsoft Xbox, Sony Playstation, or Nintendo Wii. The present invention utilizes a standard video interface and actual recorded performances, coupled with digital sheet music, to provide the music student and the music fan with a portable tool for learning music anywhere. The present invention provides a visual display of digital sheet music depicted in its most basic form, in order to give the student a low-memory high-utility media application from which to learn or enjoy music. The present invention is a media file having both video and audio content. The audio content can be an artificially-rendered MIDI file of a musical composition, but is preferably a live performance, original performance or high-quality copy of an original performance. The audio content is synchronized to video content that visually depicts digital sheet music. In some cases, a visual indicator marks what is being played when, such that the music student can read the music being played, while hearing how the music is supposed to sound. The media file is readily formatted for use with a portable media device so that the music student can view the file anywhere, anytime.

One embodiment of the invention provides for a process for playing the media file on a media device, including the steps of providing a media file having digitized sheet music content that is capable of being displayed on the media device and audio content that is capable of being played on the media device. The process further includes displaying the digital sheet music content while simultaneously playing the audio content on the media device such that the digital sheet music content and audio content are synchronized and contained in the media file.

Another aspect of the invention provides for a process for creating the media file having digital sheet music content synchronized to audio content for playback on a portable media device. The process includes the steps of providing audio content encoded in a data file with a music recording, and a digital sheet music data file containing musical score information for the music recording in the audio data file. Each note, chord, or time slice of constant duration in the digital sheet music data file is then matched to the corresponding note, chord or time slice in the audio data file. The process then generates a single media file containing the matched or synchronized content from both the audio data file and the digital sheet music data file such that when the media file is played, the digital sheet music is displayed as the corresponding audio is being sounded.

A further alternative embodiment provides a system for displaying digital sheet music on a media device. The media device has a processor configured to run a media file that may be stored on a computer-readable storage medium. The media file has video content synchronized to audio content. The media device is further capable of storing and playing the media file such that the video content is simultaneously displayed with the audio content. The system further includes a connection between the processor and the media device to enable transfer of the media file from the processor to the media device.

Yet another aspect of the invention provides a computer program product to create a media file for use in a media device, the media device having a processor, a display and the capability of playing an audio data file. The computer program product is embodied in a computer readable medium and includes computer instructions for providing an audio data file containing a music recording and a digital sheet music data file containing musical score information for the music recording in the audio data file. The program matches each note, chord, or time slice of constant duration in the digital sheet music data file to the audio data file and generates a media file containing the audio content and the digital sheet music content such that each note or chord in the audio content is synchronized to the corresponding note or chord in the digital sheet music content.

Other objects, features, and advantages of the present invention will be apparent from the accompanying drawings and from the detailed description that follows below.

### BRIEF DESCRIPTION OF THE FIGURES

The present invention is illustrated by way of example and not limitation in the Figures of the accompanying drawings, in which like references indicate similar elements, and in which:

FIG. 1 is an exemplary screen shot of the present invention on a media device such that the digital sheet music music is notated with a visual indicator of the note being heard, according to one embodiment of the present invention;

FIG. 2 is an exemplary screen shot of the digital sheet music video feature of the present invention on a media device, according to one embodiment of the present invention;

FIG. 3 is an exemplary screen shot of the present invention on a media device such that simplified choral digital sheet music music is notated with a visual indicator of the note being heard, according to one embodiment of the present invention;

FIG. 4 is an exemplary screen shot of the present invention on a media device such that simplified guitar/vocal digital sheet music music is notated with a visual indicator of the note being heard, according to one embodiment of the present invention.

### DETAILED DESCRIPTION OF THE INVENTION

A process for producing synchronized audio and digital sheet music for display on a portable media device is disclosed. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of the preferred embodiments is not intended to limit the scope of the claims appended hereto.

Aspects of the present invention may be implemented on one or more computers executing software instructions. According to one embodiment of the present invention, server and client computer systems transmit and receive data over a computer network and/or a wireless, fiber or copper-based telecommunications network. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the CPU may directly support the downloaded instructions. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers, not to any specific file format. Similarly, the present invention is not limited to any one type of memory store, and may implement devices using disk-based, CD, or DVD stores, as well as tape, flash, hard-drive or other storage methods. In some instances, the client and server functionality may be implemented on a single computer platform.

Aspects of the present invention can be used in a distributed electronic commerce application that includes a client/server network system that links one or more server computers to one or more client computers, as well as server computers to other server computers and client computers to other client computers. The client and server computers may be implemented as desktop personal computers, workstation computers, mobile computers, portable computing devices, personal digital assistant (PDA) devices, cellular telephones, digital audio or video playback devices, or any other similar type of computing device. For purposes of the following description, the terms “network,” “computer network,” and “online” may be used interchangeably and do not imply a particular network embodiment or topography. In general, any type of network (e.g., LAN, WAN, or Internet) may be used to implement the online or computer networked implementation of the present invention. Similarly, any type of protocol (e.g., HTTP, FTP, ICMP, UDP, WAP, SIP, H.323) may be used to communicate across the network. Likewise, devices implementing the present invention may use any number of wired and wireless means to connect and communicate with one another (e.g. WiFi, fiberoptic cable, telephone cable, FireWire, USB or serial cable).

The present invention is a system and process for creating, distributing and displaying a media file on a media device, where the media file is a digital sheet music video that displays the score of the music being played and displayed on the device. For clarification purposes, the verb “play” refers to the audio content of the music, whereas the verb “display” refers to the video content of the music. Further, use of the term “content,” such as in the context of audio content or video content, refers respectively to audio data or video data encoded into digital form. The term “data file” refers to one particular encoded form of “content,” but is not meant to be limiting in any way to a specific format or encoding.

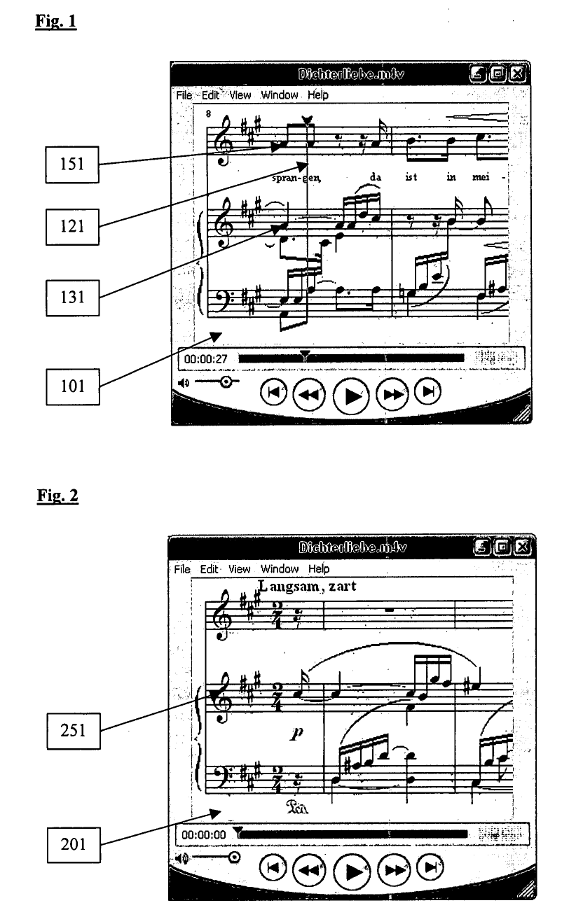

Referring now to the drawings, FIGS. 1, 2, 3 and 4 are exemplary screenshots of two embodiments of the present invention as they are being displayed on a media device. 101 of FIG. 1 points to one embodiment, while 201 of FIG. 2 points to another embodiment. FIG. 1 depicts three staves of a musical score, which may be playing simultaneously or one staff at a time. Visual indicator 121 of FIG. 1 highlights what note is being played from melody staff 151. 131 of FIG. 1 points to a note from the accompaniment to melody staff 151, which also may be highlighted by visual indicator 121. FIG. 2 is another embodiment without a visual indicator, and staff 251 of FIG. 2 is a portion of the media file being displayed without such a visual indicator highlight. One skilled in the relevant art will appreciate that displays 101 and 201 can also show a continuous staff of musical score that is formatted to wrap within the media device display screen.

### Display on a Media Device

The preferred embodiment of the present invention requires use of a media device capable of simultaneously producing sound and displaying video. Such devices include the Apple iPod, Apple iPhone, Microsoft Zune, Sony PlayStation Portable, Archos devices or the like, as well as video-enabled personal data assistants (PDA) and smartphones, such as those running PalmOS, Windows Mobile, Windows CE, Linux, Mac OS X, or Symbian. Another embodiment of the present invention envisions use of an entertainment or gaming console, such as the Nintendo Wii, Sony Playstation, Microsoft Xbox or the like, such that aspects of the present invention are displayed on an external video screen. Yet another embodiment includes use of the present invention on a personal computer or other laptop or desktop computing device attached to a display. Regardless of the device used, the display will be similar to those depicted in 101 of FIG. 1 and 201 of FIG. 2.

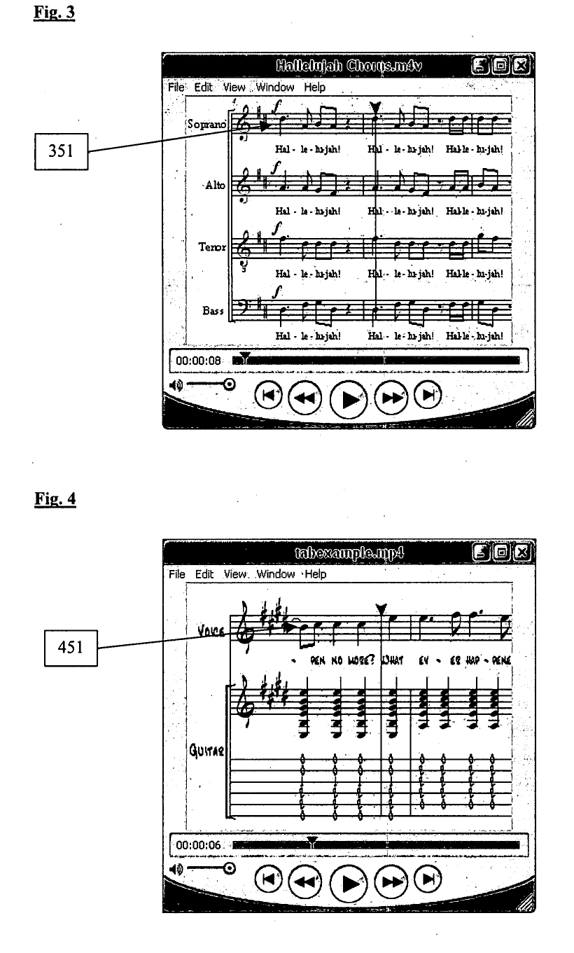

The current video iPod is limited to a 320×240 pixel screen, as are other portable music video players as of early 2007. The preferred embodiment of the present invention, therefore, needs to be set up to display well within a 320×240 pixel window. Given these restrictions, one embodiment of the present invention scales the video content of the media file such that 3-staff piano/vocal and guitar/vocal music or 4-staff a Capella choral music can be easily visualized despite this size constraint. Such a display can handle music that is solo plus accompaniment, or 4 parts without accompaniment. At this screen size, typically two to three measures of music can be displayed at a time, allowing for continuity between most measure jumps, according to one embodiment. A large repertoire of music can use digital sheet music videos despite the size and resolution constraints of today's portable devices. See, for example, 101 and 201 of FIGS. 1 and 2, respectively. Both FIGS. 1 and 2 depict a 3-staff portion of the piano/vocal musical score from a digital sheet music video. FIG. 3 depicts a 4-staff portion of a simplified choral musical score from a digital sheet music video. FIG. 4 depicts a 3-staff portion of a simplified guitar/vocal music score from a digital sheet music video. One skilled in the relevant art will appreciate that as other video-enabled portable media device players reach the market, the present invention's display can be adjusted to adapt to any number of different screen resolutions, sizes, scales and resolutions.

The present invention will allow scrolling in order to advance or rewind the displayed musical score, with a visual indicator (121 of FIG. 1) that indicates what note is being sounded. In one embodiment, scrolling advances every measure or two. In this embodiment, when the playback line reaches the edge of the screen, the score advances to the next segment and the playback line reappears at the beginning of the new segment. In another embodiment, the playback line highlights only a portion of the score, which is divided into at least two staves on the screen. When the end of the second-to-last staff is reached, the playback line advances to the staff below, and the top staff changes to reflect the next subsequent segment. When the end of the last staff is reached, the playback line advances to the top staff, and the remaining staves change to reflect the next subsequent segments. One skilled in the relevant art will appreciate that musicians reading scores tend to look ahead several measures. Effective playback allows musicians to look ahead as far as possible given the constraints of the physical display. In page-oriented digital sheet music displays, it is effective to replace the top system of the current page with the top system of the next page, once playback has reached the bottom system of the current page. This technique is based on the “Dutch door” technique used by musicians playing from paper-based scores, and has been implemented in digital sheet music stands like the MuseBook Score. It becomes effective for digital sheet music videos once the display is big enough to handle multiple systems (as on an Xbox with high-definition TV display, or an iPhone in portrait mode). In yet a further embodiment, the playback line remains static while the music scrolls smoothly beneath the line. One skilled in the relevant art will appreciate that there are many display orientation possibilities that will vary the degree of scrolling according to the media device's capabilities and features.

In a preferred embodiment of the present invention, the digital sheet music will be a scaled-down version of what is actually performed. For example, in one embodiment, choral and orchestral recordings can be synchronized with a digital sheet music display of the choral parts alone (351 of FIG. 3). Similarly, in another embodiment, popular recordings with multiple tracks and can be synchronized with simplified piano/vocal and guitar/vocal arrangements suitable for solo performers learning a piece (451 of FIG. 4). One skilled in the relevant art will appreciate that further simplifications are possible, including chord sheets that contain just the lyrics and chords, without the detailed pitch and rhythm information provided in traditional sheet music.

One skilled in the relevant art will appreciate that the utility of the present invention is not limited to portable media devices. For example, entertainment and game consoles such as the Nintendo Wii, Sony Playstation or Microsoft Xbox 360, and other media technologies, such as Apple iTV, which can play high-definition content, allow the present invention's digital sheet music video technology to be enjoyed without the display and resolution limitations of portable media devices. One will appreciate that although the preferred embodiment is disclosed with reference to media devices, as technology advances, and new devices are brought to the market, the present invention will no doubt work on these devices.

### The Media File

Implementation of the present invention requires generation of the media file and distribution of this file to media devices. Creation of the media file involves four general steps: (1) providing a score encoded into video content; (2) providing audio content; (3) synchronizing the score and audio content; (4) packaging the synchronized file into video format; and then (5) transferring the packaged media file to a media device. What follows is a detailed discussion of some embodiments of these five steps, using commercially available software to create the proprietary invention disclosed herein.

Creating the media file can either be done manually or automatically. In one embodiment of the present invention, the process for manually creating a media file for display on a portable media device, such as an Apple iPod, comprises the following steps:

1. Acquire or create the “score” for the song. In a first step for this particular embodiment, a music score file must be acquired or created. One skilled in the relevant art will appreciate that this is the same file that could be used to produce printed sheet music. Such files could be made using commercially-available software, such as Finale®, which is a product and trademark owned by MakeMusic, Inc. A relevantly skilled artisan will appreciate that other notation programs like Sibelius or Notion can also be used, with some variation of the disclosed process. For example, in another embodiment, a score file from Sibelius, Notion, or other such programs is imported into Finale after first exporting the score file into MusicXML format, and then importing the MusicXML file into Finale. MusicXML is an XML-based music notation file format developed by Recordare LLC, the assignee of the present invention.

2. Acquire or create the audio content for the song. Preferably, the audio content is a WAV or AIFF file extracted from an audio CD (thus preserving the song's original sound quality). Alternatively, the audio file could be a WAV or AIFF file created directly from Finale from the MIDI playback.

3. Synchronize the audio content with the score file. This step requires some initial preparation. As mentioned previously, the present invention comprises a media file with video score content and audio content. Creation of a correctly synchronized file requires matching up the tempo of the audio file with the score file.

The preferred embodiment of the present invention envisions the use of the media file format with many different musical genres. One skilled in the art will recognize that different genres of music have different steadiness of tempo. As such, manual synchronization for these different genres of music will require slightly different synchronization techniques. For example, classical music typically involves many tempo changes within one song. In one embodiment of the present invention, Finale is used to synchronize the audio file with the score file, wherein the tempo of the recorded music is “tapped” in. In this embodiment, Finale permits the user to tap every beat (e.g. every quarter note in 4/4, every dotted quarter in 6/8). One will appreciate that it is usually easier instead to follow either the solo line in solo+accompaniment music, or the top line such as the soprano in a soprano, alto, tenor, and bass (SATB) choral arrangement, rather than attempt synchronization of all the music streams. In this embodiment, this is done by going to Finale's Studio View and copying the solo or top line to the TempoTap™ staff that appears at the top of the display. One will appreciate that this may need further adjustment if the solo or top line drop out for a significant time. One will also appreciate that the use of other notation programs will permit these same actions, but in a slightly different manner.

In another embodiment, where pop music is the musical genre, a metronome is used to determine the appropriate tempo since pop music usually has few tempo changes. In this embodiment, tempo indications may be added to the Finale score file at the beginning of the piece and perhaps in a few places thereafter.

Once the notation program, the score file and the audio file are prepared, synchronization may begin. In a preferred embodiment, Finale's TempoTap mode (Hyperscribe tool working in Studio View) is utilized by hitting the space bar for each note and notated rest in the TempoTap part while listening to the audio file on another device. This is usually following the solo or top line as described previously. In this embodiment, the audio file playback needs to be controlled on a separate device because one cannot synchronize the start of the piece if controlling the start of audio playback on the same computer that is controlling the start of recording tempo changes. However, this is a limitation of the current notation software used in this example, and one will appreciate that other methods protected by this patent may obviate the need for external playback control.

The preferred process for the present invention encourages a quality control step to ensure the quality of the synchronized media file. In this embodiment, this is done by reviewing the Finale score file for synchronization by playing the file back in Finale while listening to the audio. The manual TempoTap method can accumulate roundoff errors over time such that score playback drags behind the audio as the music progresses. This can be compensated for via manual tempo edits.

Once the user is satisfied with the resulting synchronized media file, this file is saved and stored on a memory device with all the corrected tempo adjustments.

4. Set up for screencam recording. This step of the preferred embodiment creates the appropriate video content for the media file. In this embodiment, the user adjusts Finale so that the music plays back in a 320×240 pixel window captured by a screencam or screen capture program. This screencam program is also commercially available. In one embodiment, TechSmith's Camtasia Studio 4 was used for the screencam while Finale's Scroll View was used for the best playback animation. Finale screen colors were turned off to enhance visualization.

To create the recorded file, the recently synchronized Finale score file is played back while Camtasia Studio records the screen display. This creates the animated video content, which may include the playback line visual indicator. Audio is not included in the recording, just the screen video.

After the video file is recorded, it is edited to remove the time between the start of the Camtasia recording and the start of playback, then the audio file is added to the screencam. Additional editing may be required so that recorded video playback lasts as long as the audio. One skilled in the art will appreciate that this may involve freezing the last frame of the video and extending it until the audio ends. Sometimes the audio from a CD file will have extra silence at the end which should be edited out as part of this synchronization.

This file may then be converted to any relevant format in order to create the final digital sheet music video. In a preferred embodiment, the file is converted to MPEG-4 format for playback on a video-enabled Apple iPod. In another embodiment, the file is converted to Flash Video format for playback on a Flash-enabled personal computer or cell phone. One will appreciate that there are many viable file formats available, and that these disclosed embodiments are not meant to be limiting in any way.

5. The final step requires distribution from the computing device used to create the digital sheet music video, to a secondary media device. In a preferred embodiment, Apple iTunes is used to transfer the media file to a video-enabled iPod. In another embodiment, Microsoft Zune software is used to transfer the media file to a Microsoft Zune media device. In yet another embodiment, the file is transferred to an entertainment console, such as a Sony PlayStation, Nintendo Wii, Microsoft Xbox or similar device. One skilled in the relevant art will appreciate that the media file may be played on a number of non-desktop or PC-based media devices, freeing the user from enjoying the benefits of the present invention on solely desktop or laptop computers.

### Where the Process can be Automated

While the present invention has been described using a manual creation process, one skilled in the relevant art will appreciate that as technology develops, the creation process can be partially or completely automated. For example, pop music with static beats can be synchronized by using beat extraction from audio recordings to determine appropriate tempos (Scheirer, 1998; Kurth et al, 2006). Classical music can be synchronized using dynamic time warping (Sankoff and Kruskal, 1983) to match the symbolic representation of the music to the audio recording. This would be done using chroma representations (Bartsch and Wakefield, 2001, 2005) of both the score and the audio performance (Dannenberg and Hu, 2003). Well-designed multiscale dynamic time warping makes this method more computationally efficient, especially for longer classical works (Müller et al., 2006). In one embodiment of the present invention, automation might combine the beat tracking and time warping methods to get the most accurate and efficient results. Such automation will increase the commercial viability of the present invention, as well as allow more efficient creation of a number of media files for many different genres of music.

At present, one embodiment envisions usage of a chroma representation as a common format to compare audio and score files. Chroma representations use a 12-element vector describing how much volume is present for each note in a 12-tone chromatic scale, regardless of octave. These samples can be taken every ¼ second or so. The chroma file for audio can be created using FFT (Fast Fourier Transform) technology. The chroma file for a score can be created by either creating an audio file from the score and creating the chroma from that, or creating the chroma file synthetically directly from the score file. This misses out on the contributions of acoustic elements such as percussion instruments and reverberation to the chroma that would be created via an audio file. However, those skilled in the art recognize that these missing elements may not matter for purposes of creating an effective automatic synchronization.

The prior described manual process above can thus be automated by using dynamic time warping based on the chroma representations of the audio and score files:

Save the Finale score file as a MusicXML score file.

Create a chroma file from the MusicXML score file.

Create a chroma file from the audio file.

Time warp the score file to match the audio file.

Convert the dynamic time warping data into a tempo-based data format.

What is needed for synchronization are the tempos required at each point in the score file to make the playback of the score file match the audio file.

Import this tempo information back into Finale. This might be through importing a MusicXML file that includes the tempo data, or through importing the data through a special-purpose tempo XML file that contains the tempo indications in Finale-compatible terms. Doing the latter would remove the inaccuracies from a Finale—MusicXML—Finale round trip. Tempo information created using dynamic time warping with a complete digital sheet music file can also be imported into Finale files containing derivative simplified versions of the sheet music such as chord sheets or selected parts. On their own, these simplified files would not contain enough musical data to generate an accurate chroma representation, and thus could not be automatically synchronized with the audio file.

The tempo data import may need to be corrected for Finale's tempo roundoff errors so that score playback does not lag behind the audio file.

Save the synchronized Finale score file.

For pop music or other genres of music that do not change tempo often, it is possible that beat tracking technology might work better, and in some cases faster, than dynamic time warping technology. At present, dynamic time warping serves the widest variety of music; however, one skilled in the relevant art will appreciate that the present invention also includes beat tracking methods or other developing or present automated processes useful for creating the media file. One will appreciate that the programs, methods, steps and combinations thereof described herein are merely exemplary, and are not meant to be limiting in any way.

Other steps in the process could be automated as well. For example, Finale has various technologies for avoiding vertical and horizontal collisions between objects. These could be adapted to apply to Scroll View as well as Page View via a plug-in to create a semi-automated process. Batch processes are available or may be written for reading and writing folders of MusicXML files, as used in Recordare's “Dolet 3 for Finale” plug-in. This could be applied to control the overall flow within Finale. The program could also be extended to control the overall flow of Finale and Camtasia as well. One skilled in the relevant art will appreciate that there are many options available that can be encoded and programmed to afford automation of various or all steps in the disclosed process.

Although embodiments of the present invention have been described with reference to a network implementation comprising the internet and internet-related web browsing and web serving technologies, it should be noted that alternative embodiments of the present invention can be implemented on many other types of networks and network protocols, such as proprietary protocols for local area networks, wide area networks, physical transfer via CD, DVD, or USB flash memory sticks, and any combination thereof.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than restrictive sense.

What is claimed is:

1. A process for playing a media file on a media device comprising the steps of:
providing a media file having digital sheet music content that is capable of being displayed on the media device, and audio content that is capable of being played on the media device;
displaying the digital sheet music content while simultaneously playing the audio content on the media device such that the digital sheet music content and audio content are synchronized and contained in the media file.

2. The process of claim 1, further comprising the step of transferring the media file to a media device before playing the media file on the media device.

3. The process of claim 1, wherein the audio content of the media file is a reproduction of a song's master recording.

4. The process of claim 1, wherein the digital sheet music comprises musical score content scaled for display on a portable media device screen.

5. The process of claim 1, wherein the digital sheet music comprises musical score content that has been simplified for display on a portable media device screen.

6. The process of claim 1, wherein during the playing step, the media file displays a visual indicator showing what musical note from the digital sheet music is being audibly presented by the audio content.

7. A process for creating a media file having digital sheet music content synchronized to audio content for playback on a portable media device comprising the steps of:
(a) providing an audio data file containing a music recording;
(b) providing a digital sheet music data file containing musical score information for the music recording in the audio data file;
(c) matching each note or chord of the digital sheet music data file to the audio data file; and
(d) generating a media file containing the audio content and the digital sheet music content such that each note or chord in the audio content is synchronized to the corresponding note or chord in the digital sheet music content.

8. The process of claim 7, further comprising the step of adding a visual indicator to the digital sheet music content, the visual indicator synchronized to the music recording of the audio content such that when a musical note or chord is sounded by the audio content, the corresponding note or chord from the musical score information is highlighted.

9. The process of claim 7, wherein the matching step comprises mapping each time slice of constant duration in the audio data file and the digital sheet music data file.

10. The process of claim 7, wherein the matching step uses dynamic time warping.

11. The process of claim 7, wherein the matching step uses beat tracking.

12. A system for displaying digital sheet music on a media device comprising:
(a) a processor configured to run a media file, the media file stored on a computer-readable storage medium and having video content synchronized to audio content;
(b) a media device capable of storing and playing the media file such that the video content is simultaneously displayed with the audio content; and
(c) a connection between the processor and the media device to enable transfer of the media file from the processor to the media device.

13. The system of claim 12, wherein the connection between the processor and the media device is a wired connection.

14. The system of claim 12, wherein the connection between the processor and the media device is a wireless connection.

15. A computer program product for use in a media device having a processor, a display and the capability of playing an audio data file, the computer program product being embodied in a computer readable medium and comprising computer instructions for displaying video content of digital sheet music synchronously associated with audio content.

16. The computer program product of claim 15, wherein the audio content of the media file is a reproduction of a song's master recording.

17. The computer program product of claim 15, wherein the digital sheet music comprises musical score content scaled for display on a portable media device screen.

18. The computer program product of claim 15, wherein the digital sheet music comprises musical score content simplified for display on a portable media device screen.

19. The computer program product of claim 15, wherein during the playing step, the media file displays a visual indicator showing what musical notes from the digital sheet music is being audibly presented by the audio content.

20. A computer program product for use in a computing device having a processor, a display and the capability of playing an audio data file, the computer program product being embodied in a computer readable medium and comprising computer instructions for:
(a) providing an audio data file containing a music recording;
(b) providing a digital sheet music data file containing musical score information for the music recording in the audio data file;
(c) matching each note or chord of the digital sheet music data file to the audio data file; and
(d) generating a media file containing the audio content and the digital sheet music content such that each note or chord in the audio content is synchronized to the corresponding note or chord in the digital sheet music content.

21. The computer program product of claim 20, further comprising adding a visual indicator to the digital sheet music content, the visual indicator synchronized to the music recording of the audio content such that when a musical note or chord is sounded by the audio content, the corresponding note or chord from the musical score information is highlighted.

22. The computer program product of claim 20, wherein the computer instructions for matching the digital sheet music data file to the audio data file are at least partially automated.

23. The computer program product of claim 20, wherein the computer instructions for matching each note or chord further comprises mapping each time slice of constant duration in the audio data file and the digital sheet music data file.

24. The computer program product of claim 20, wherein the computer instructions for matching each note or chord uses dynamic time warping.

25. The computer program product of claim 20, wherein the computer instructions for matching each note or chord uses beat tracking.
